(19) United States
(12) Patent Application Publication
(10) Pub. No.: US 2004/0203308 A1
(43) Pub. Date: Oct. 14, 2004

(54) Process for making absorbent material

(76) Inventors: Young Chan Ko, Neenah, WI (US); Stanley R. Kellenberger, Appleton, WI (US); Kambiz Bayat Makoui, Neenah, WI (US)

Correspondence Address: Melanie I. Rauch, Pauley Petersen Kinne & Erickson, Suite 365, 2800 West Higgins Road, Hoffman Estates, IL, 60195, US

(21) Appl. No.: 10/410,222

(22) Filed: Apr. 9, 2003

(51) Int. Cl. B32B 5/16; D04H 3/00; D04H 1/00

(52) U.S. Cl. 442/352; 442/400; 442/401; 442/417; 526/72

(57) ABSTRACT

A process for making an absorbent material involves flash-drying a superabsorbent polymer precursor composition. The process may be used to make a superabsorbent-fiber material without the necessity of mixing conventional superabsorbent solid particles with pulp fluff is provided. The synthesis (i.e., polymerization) of the superabsorbent is completely integrated into the process for forming the absorbent material. One or more streams of superabsorbent polymer precursor composition are provided, to which a plurality of individual fibers may be added. The resulting in-situ polymerized superabsorbent-fiber material is then flash-dried and can subsequently be formed into a superabsorbent-fiber composite. The flash-drying is relatively inexpensive and requires little drying time compared to conventional drying methods.

### BACKGROUND OF THE INVENTION

This invention is directed to a process for making absorbent material useful in tissue and wiping absorbent articles, personal care absorbent articles, medical absorbent articles and the like, in which a superabsorbent polymer component of the absorbent material is synthesized during manufacture of the absorbent material.

Processes for making absorbent composite materials having a superabsorbent polymer component are known. In various processes, preformed superabsorbent polymer particles or fibers are combined with cellulose fibers, thermoplastic fibers and the like in a web formation process to make a composite web structure. Illustrative processes are disclosed in U.S. Pat. No. 4,818,464 to Lau, U.S. Pat. No. 4,100,324 to Anderson et al., U.S. Pat. No. 5,350,624 to Georger et al., and U.S. Pat. No. 4,902,559 to Eschwey et al. These processes are commonly referred to as “coform” processes.

Direct co-forming of fibers with liquid monomers to form an in-situ polymerized superabsorbent (ISPS)-fiber composite is known. Such ISPS-fiber composite generally has about 30%-70% solid content and about 70%-30% of water, unreacted monomers, intermediate products such as uncrosslinked ISPS, and unused initiators and crosslinking agents. To complete the ISPS reaction of the intermediate products and to eliminate unreacted monomers and extractables, post-treatment of the ISPS-fiber composite is typically carried out by surface-crosslinking, UV treatment, electronic beam treatment, and drying of the ISPS-fiber composite from the ISPS reactor. Various techniques for drying the wet ISPS-fiber composites have been used, including through-air drying, infrared drying, and drum drying. However, all of these conventional drying and curing methods are energy-intensive processes and usually require a long drying time (minutes to several hours) at a relatively low temperature in order to avoid thermally degrading the raw materials such as ISPS, cellulose fibers, and synthetic fibers. This degradation can occur at temperatures above about 110 degrees Celsius when these types of material are exposed for an extended period of time. For example, greater than about 5 minutes in the case of wood pulp.

There is thus a need or desire for a process for making absorbent composites in which drying cost and drying time are reduced without sacrificing absorbency of the finished product.

### SUMMARY OF THE INVENTION

This invention is directed to a process for making an absorbent material in which in-situ polymerized superabsorbent-fiber material, or superabsorbent-particulate material, is flash-dried. The invention is also directed to absorbent articles made from such absorbent material.

The absorbent material can be made by providing one or more superabsorbent polymer precursor compositions capable of polymerizing upon initiation. More particularly, a first superabsorbent polymer precursor composition may be a monomer solution containing a reducing initiator, such as L-ascorbic acid dissolved in an aqueous solution of a partially neutralized salt of acrylic acid. A second superabsorbent polymer precursor composition may be a monomer solution containing an oxidizing initiator, such as an aqueous solution of hydrogen peroxide homogenized with an aqueous solution of a partially neutralized salt of acrylic acid. Alternatively, radiation-induced initiation may occur.

The one or more superabsorbent polymer precursor compositions are combined in a reactor. A plurality of individualized fibers can be added to the reactor during in-situ polymerization of the liquid monomers. When the superabsorbent polymer precursor compositions initially contact each other inside an ISPS reactor in the presence of the fibers, the polymerization reaction proceeds in combination with the fibers, resulting in an in-situ polymerized superabsorbent-fiber material. The in-situ polymerized superabsorbent-fiber material can be flash-dried, suitably at a temperature greater than about 150 degrees Celsius. A superabsorbent-fiber composite can then be formed from the flash-dried material. More particularly, the superabsorbent-fiber composite may be formed into bales, rolls, or sheets for transporting the material to manufacturers of absorbent articles. Alternatively, a metering-forming system can be used to enable direct manufacturing of absorbent articles. In either case, this method eliminates the necessity of mixing conventional superabsorbent solid particles with pulp fluff to produce an absorbent article, and this method provides the additional advantage of significantly reducing drying costs and time to dry. Furthermore, the resulting superabsorbent-fiber composite possesses a controlled, stable composition in which the superabsorbent polymer combines with the fibers and does not migrate within or away from the absorbent composite.

In another embodiment, individualized fibers are not added to the reactor. Instead, polymerization of the superabsorbent polymer precursor compositions is carried out, and the resulting polymerized superabsorbent-particulate material is then flash-dried, suitably at a temperature greater than about 150 degrees Celsius. An absorbent material can then be formed from the flash-dried material. This embodiment also provides the advantage of significantly reducing drying costs and drying time.

With the foregoing in mind, it is a feature and advantage of the invention to provide a method of making an absorbent material with relatively low drying costs and relatively low drying time.

### BRIEF DESCRIPTION OF THE DRAWINGS

These and other objects and features of this invention will be better understood from the following detailed description taken in conjunction with the drawings, wherein:

FIG. 1 is a schematic diagram of one embodiment of the method of the invention.

FIG. 2 is a schematic diagram of another embodiment of the method of the invention.

FIG. 3 is a schematic diagram of yet another embodiment of the method of the invention.

### DEFINITIONS

Within the context of this specification, each term or phrase below will include the following meaning or meanings.

The term “cellulose fibers” refers to fibers from natural sources such as woody and non-woody plants, regenerated cellulose, and derivatives from these fibers by means of chemical, mechanical or thermal treatment, or any combination of these. Woody plants include, for example, deciduous and coniferous trees. Non-woody plants include, for instance, cotton, flax, esparto grass, milkweed, straw, jute hemp, and bagasse. Regenerated cellulose fibers include, for instance, viscose and rayon. The cellulose derivatives include, for instance, microcrystalline cellulose, chemically crosslinked fibers, and chemically uncrosslinked, twisted fibers.

The term “meltblown fibers” means fibers formed by extruding a molten thermoplastic material through a plurality of fine, usually circular, die capillaries as molten threads or filaments into converging high velocity heated gas (e.g., air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed for example, in U.S. Pat. No. 3,849,241 to Butin et al. Meltblown fibers are microfibers which may be continuous or discontinuous, are generally smaller than 10 microns in diameter, and are generally self bonding when deposited onto a collecting surface.

The term “spunbonded fibers” refers to small diameter fibers which are formed by extruding molten thermoplastic material as filaments from a plurality of fine capillaries of a spinnerette having a circular or other configuration, with the diameter of the extruded filaments then being rapidly reduced as by, for example, in U.S. Pat. No. 4,340,563 to Appel et al., U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartman, U.S. Pat. No. 3,502,538 to Petersen, and U.S. Pat. No. 3,542,615 to Dobo et al. Spunbond fibers are quenched and generally not tacky on the surface when they enter the draw unit, or when they are deposited onto a collecting surface. Spunbond fibers are generally continuous and may have average diameters larger than 7 microns, often between about 10 and 30 microns. In both cases above the fibers are attenuated to their final diameter by aerodynamic drawing processes.

The term “staple filaments or fibers” means filaments or fibers which are natural or which are cut from a manufactured filament prior to forming into a web, and which have a length ranging from about 0.1-15 cm, more commonly about 0.2-7 cm.

The term “microfibers” means small diameter fibers having an average diameter not greater than about 75 microns, for example, having an average diameter of from about 0.05 micron to about 50 microns, or more particularly, having an average diameter of from about 0.1 micron to about 10 microns, or even more typically 0.5 micron to about 5 microns.

The term “polymer” generally includes but is not limited to, homopolymers, copolymers, including block, graft, random and alternating copolymers, terpolymers, etc. and blends and modifications thereof. Furthermore, unless otherwise specifically limited, the term “polymer” shall include all possible geometrical configurations of the material. These configurations include, but are not limited to isotactic, syndiotactic and atactic symmetries.

The term “thermoplastic” is meant to describe a material that softens and flows when exposed to heat and which substantially returns to its original hardened condition when cooled to room temperature.

The term “superabsorbent polymer precursor composition” refers to any and all solutions which, when mixed, chemically reacts to form a superabsorbent polymer. Each solution may be comprised of any combination of oligomer(s), monomer(s), crosslinking reagent(s), neutralizing agent, or initiator(s). In instances when only a single solution is utilized all the desired components must be in said solution and the initiator(s) must require a later activation step (e.g. heating or irradiation). In instances when two or more solutions are utilized the initiator(s) is most often, but not limited to, a chemical redox pair. When a redox pair, comprised of an oxidizing radical generator and a reducing agent, is used as the initiator the oxidizing radical generator and reducing agent must be in separate solutions. The solution of oxidizing radical generator or reducing agent may also contain any combination of oligomer(s), monomer(s), crosslinking reagent(s), or neutralizing agent.

The terms “elastic” and “elastomeric” are used interchangeably to mean a material that is generally capable of recovering its shape after deformation when the deforming force is removed. Specifically, as used herein, elastic or clastomeric is meant to be that property of any material which upon application of an elongating force, permits that material to be stretchable to a stretched length which is at least about 25 percent greater than its relaxed length, and that will cause the material to recover at least 40 percent of its elongation upon release of the stretching elongating force. A hypothetical example which would satisfy this definition of an elastomeric material would be a one (1) inch sample of a material which is elongatable to at least 1.25 inches and which, upon being elongated to 1.25 inches and released, will recover to a length of not more than 1.15 inches. Many elastic materials may be stretched by much more than 25 percent of their relaxed length, and many of these will recover to substantially their original relaxed length upon release of the stretching, elongating force.

The term “superabsorbent material” refers to a water swellable, water-insoluble organic or inorganic material capable, under the most favorable conditions, of absorbing at least about 10 times its weight, suitably at least about 20 times its weight in an aqueous solution containing 0.9% by weight sodium chloride. The term “absorbent material” refers to any material capable of absorbing from about 5 to less than about 15 times its weight of the same solution.

The term “nonwoven” or “nonwoven web” refers to materials and webs or material having a structure of fibers or filaments which are interlaid, but not in an identifiable manner as in a knitted fabric. The terms “fiber” and “filament” are used interchangeably. Nonwoven fabrics or webs have been formed from many processes such as, for example, meltblowing processes, spunbonding processes, air laying processes, and bonded carded web processes. The basis weight of nonwoven fabrics is usually expressed in ounces of material per square yard (osy) or grams per square meter (gsm) and the fiber diameters are usually expressed in microns. (Note that to convert from osy to gsm, multiply osy by 33.91.)

The term “personal care absorbent article” includes diapers, training pants, swim wear, absorbent underpants, adult incontinence products, feminine hygiene products, and the like.

The term “tissue and wiping absorbent article” includes facial tissue, paper towels such as kitchen towels, away-from-home towels, wet-wipes, and the like.

The term “medical absorbent article” includes medical absorbent garments, drapes, gowns, bandages, wound dressings, underpads, wipes, and the like.

These terms may be defined with additional language in the remaining portions of the specification.

### DESCRIPTION OF PREFERRED EMBODIMENTS

In accordance with the invention, an absorbent material can be made by polymerizing one or more superabsorbent polymer precursor compositions, and optionally combining individualized fibers with in-situ polymerized superabsorbent (ISPS) particles during in-situ polymerization of the liquid monomers, followed by flash-drying the polymerized superabsorbent-particulate material or the in-situ polymerized superabsorbent-fiber material.

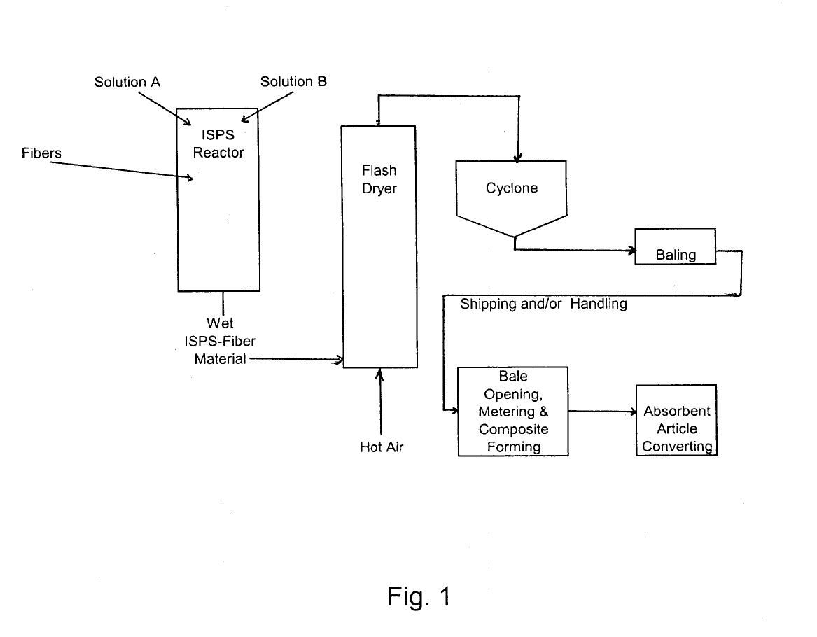

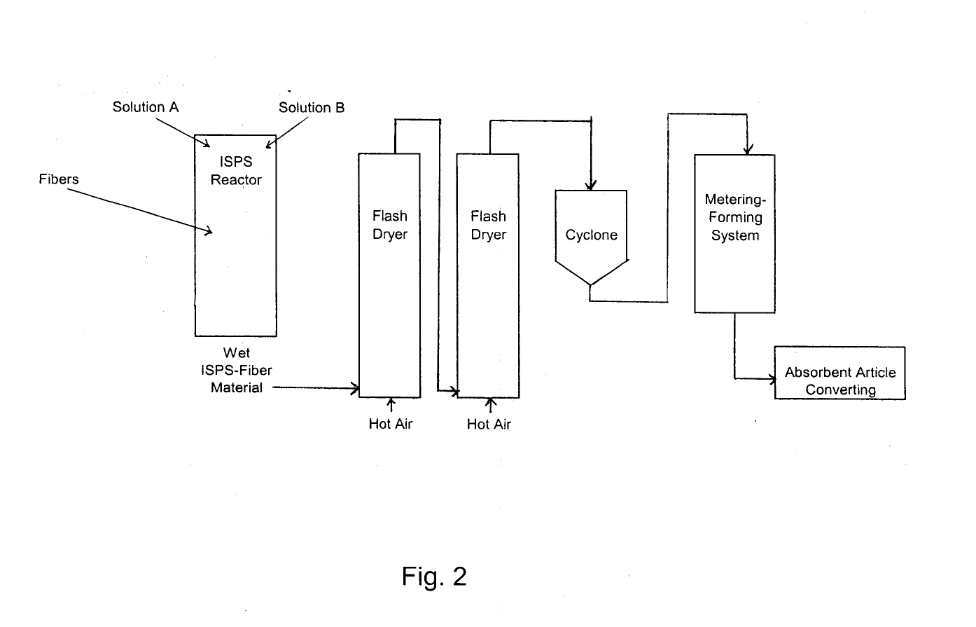

Schematic diagrams of producing the absorbent material are illustrated in FIGS. 1 and 2. One or more separate streams of superabsorbent polymer precursor compositions (Solution A and Solution B, for example) are combined in an ISPS reactor to form an in-situ polymerizable monomer solution. By “separate streams” it is meant that the precursor compositions are poured into the ISPS reactor in a manner where they do not contact each other before they are in the ISPS reactor. Also, the superabsorbent polymer precursor compositions are selected so that they do not polymerize or otherwise chemically react before they make contact with each other or with another initiation device. Upon colliding the streams or otherwise activating initiation, ISPS reaction starts instantly, or almost instantly, with a conversion rate of about 50%-90% within less than about 5 seconds, under suitable conditions. During the in-situ polymerization process, a plurality of individualized fibers are added to the ISPS reactor. The fibers combine with the in-situ polymerizable monomer solution to form an in-situ polymerized superabsorbent-fiber material.

A ratio of ISPS to fiber in the ISPS-fiber material can be changed by adjusting a feed rate ratio between the ISPS solution feed rate and the fiber feed rate into the ISPS reactor. A higher ratio of ISPS solution feed rate to fiber feed rate results in a higher concentration of ISPS in the ISPS-fiber material. This, in turn, makes thinner absorbent composites possible. More particularly, the ratio of the in-situ polymerizable monomer solution feed rate to the fiber feed rate into the ISPS reactor is suitably between about 5:95 and about 95:5 (based on solids in monomer solution), resulting in the ISPS-fiber material having the ISPS and the fibers in a ratio between about 1:19 and about 19:1.

In conventional solid SAP-fiber mixing methods it is difficult to produce SAP-fiber composites having more than 50% SAP without the use of some additional binder material which generally lends other undesirable characteristics such as hydrophobicity or stiffness effects. The method of the invention enables addition of a large amount of ISPS to fiber, such as 60% or more ISPS in the composite (150% or higher ISPS add-on over fiber) while maintaining core integrity and flexibility.

The ISPS-fiber material made in the ISPS reactor may contain about 20% to about 70% water, or about 30% to about 60% water, and a small amount of unreacted monomers and extractables. A suitable amount of the excess water, unreacted monomers, and extractables may be removed from the ISPS-fiber material by flash drying the ISPS-fiber material in a hot air (or gas) stream at a temperature greater than about 150 degrees Celsius, or between about 150 and about 500 degrees Celsius, or greater than about 200 degrees Celsius, or greater than about 300 degrees Celsius, for less than about 30 seconds, or less than about 20 seconds, or between about 0.1 seconds to about 10 seconds. Due to the high level of heat in the flash drying process, the partially hydrated fibers in the ISPS-fiber material tend to be twisted and curled during the flash drying, resulting in additional integrity and flexibility within the ISPS-fiber materials.

Optionally, as shown in FIG. 2, multi-stage flash-drying can be used, in which the ISPS-fiber material is exposed to two or more flash dryers. The flash dryers may be set at different temperatures, and/or may be used to expose the ISPS-fiber material to heat for different periods of time. For example, the ISPS-fiber material may pass through a first flash dryer set at a high enough temperature to twist and curl the material, and a second flash dryer set at a lower or more moderate temperature to complete the drying of the material.

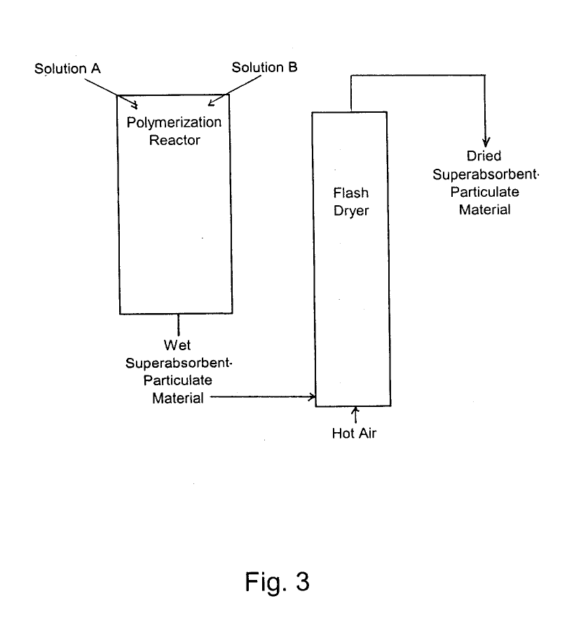

In another embodiment of the invention, illustrated in FIG. 3, the method can be carried out without adding fibers to the superabsorbent polymer precursor composition or compositions. Instead, polymerization of the superabsorbent polymer precursor composition or compositions results in a superabsorbent-particulate material. The superabsorbent-particulate material can then be flash-dried in the same manner as the ISPS-fiber material is flash-dried in any of the previously described embodiments of the invention. The flash-dried superabsorbent material can be used in the same manner as conventional superabsorbent material. More particularly, the polymerized superabsorbent-particulate material can be added to a substrate to form a superabsorbent composite structure. As used herein, the term “add” refers to mixing with, depositing onto, or otherwise combining one substance with another. The superabsorbent composite structure can be attached to a second substrate to form a laminate. The superabsorbent composite structure and/or the laminate can be used to form absorbent articles.

Since flash drying can be completed in such a short time, even heat-sensitive materials, such as ISPS and wood pulp, can be dried at such high temperatures without causing thermal degradation of these materials. Conventional drying and curing methods such as through-air drying, infrared drying, UV or electron-beam curing, or drum drying are typically time-consuming, and although they are energy-intensive, these methods may not be able to provide such high temperatures for drying the ISPS-fiber material or the superabsorbent-particulate material without causing thermal damage, or at least would require considerable capital investment to be as effective as flash drying. Furthermore, the high flash drying temperatures may eliminate the extractables, such as residual monomers and other undesirable components in the ISPS-fiber material or the superabsorbent-particulate material, thus eliminating any need for the energy-intensive, time-consuming post-treatment steps typically used in conventional drying methods.

The ISPS-fiber material can be collected at the outlet of the reactor and sent to a conventional flash dryer or a series of flash dryers, as shown in FIGS. 1 and 2. Mechanical feeders such as a fan, fluffer, imp mill, fiberizer, and the like may be used to feed the ISPS-fiber material to the flash dryer. The flash-dried ISPS-fiber material can be collected through a cyclone or other collecting device, and may thereafter be metered and formed into a superabsorbent-fiber composite using such equipment as RANDO-FEEDER volumetric feeders using vacuum, conveyor speed and height of scarfing pin rolls, and the like. The flash-dried ISPS-fiber material can also be made into a bale form for easy transportation to manufacturers of absorbent articles, as illustrated in FIG. 1. The bale form can subsequently be opened and metered to form absorbent articles. Whether the flash-dried ISPS-fiber material is metered and formed, or baled and subsequently metered and formed, the formed absorbent material can be shaped into various two-dimensional or three-dimensional articles, such as pant-like garments for example.

Suitably, the ISPS-fiber material is dry, such as less than about 10% moisture, or less than about 5% moisture, or less than about 3% moisture, when pressing the bale as in FIG. 1. One approach to obtaining a dry bale is by having smaller particles in the bale. More particularly, if there is high residual moisture in the center of the particles, which is more likely to occur in larger particles because of the greater distance from the center of the particle to the surface, as the particle equilibrates, the moisture content of the ISPS particles' surfaces may get high enough while still in the compressed bale to result in hydrogen bonding and therefore the bale will be very hard to open for processing into the converting line. Suitably, ISPS-fiber material wherein most of the ISPS particles are smaller than about 500 micrometers is acceptable. More particularly, more than about 60% of the ISPS particles are less than about 500 micrometers across when observed microscopically from some direction.

Alternatively, the flash-dried ISPS-fiber material can be made into continuous festooned sheet or roll form instead of going directly into the absorbent article converting, as illustrated in FIG. 2. This is an alternative method to baling for ease and economy for transportation to manufacturers of absorbent articles, as illustrated in FIG. 1. In this case, bale opening, metering and composite forming is not necessary. Instead, roll unwinding or defestooning equipment is utilized.

Optionally, a nonwoven substrate may be employed after the cyclone so that ISPS-fiber material would be deposited onto it in the metering forming system to produce ISPS-fiber laminated nonwoven substrate. As a nonwoven substrate, either hydrophilic or hydrophobic material may be used. The nonwoven substrate can be wet-formed like paper (ranging from tissue to towel to board and the like) or dry formed (bonded carded webs, spunbonded webs, meltblown webs, cross-laid scrims, air laid webs, and the like).

Optionally, any suitable substrate, such as woven (cloth or scrim), film, or foam may be employed after the cyclone so that ISPS-fiber material would be deposited onto it to produce an ISPS-fiber laminated composite structure.

Alternatively, as shown in FIG. 2, the ISPS-fiber material can be directly co-formed into the superabsorbent-fiber composite by passing the ISPS-fiber material, either directly or indirectly, from the cyclone into a metering-forming system, which prepares the resulting superabsorbent-fiber composite for conversion into absorbent articles. In either case, the method of the invention eliminates the necessity of mixing conventional superabsorbent solid particles with fibers to produce an absorbent composite, and has the further advantage of significantly reducing drying costs and drying time. Furthermore, superabsorbent containment in the superabsorbent-fiber composite is greatly enhanced compared to absorbent composites in which conventional superabsorbent solid particles are mixed with fibers.

A wide variety of superabsorbent polymer precursor compositions may be employed in the process of the invention. At least one polymer precursor composition may include a monomer. Suitable superabsorbent-forming monomers include the following monomers, and combinations thereof:

1. Carboxyl group-containing monomers: monoethylenically unsaturated mono or poly-carboxylic acids, such as (meth)acrylic acid (meaning acrylic acid or methacrylic acid. Similar notations are used hereinafter), maleic acid, fumaric acid, crotonic acid, sorbic acid, itaconic acid, and cinnamic acid;

2. Carboxylic acid anhydride group-containing monomers: monoethylenically unsaturated polycarboxylic acid anhydrides (such as maleic anhydride);

3. Carboxylic acid salt-containing monomers: water-soluble salts (alkali metal salts, ammonium salts, amine salts, etc.) of monoethylenically unsaturated mono- or poly-carboxylic acids (such as sodium (meth)acrylate, trimethylamine(meth)acrylate, triethanolamine(meth)acrylate, sodium maleate, methylamine maleate;

4. Sulfonic acid group-containing monomers: aliphatic or aromatic vinyl sulfonic acids (such as vinylsulfonic acid, allyl sulfonic acid, vinyltoluenesulfonic acid, styrene sulfonic acid), (meth)acrylic sulfonic acids [such as sulfopropyl (meth)acrylate, 2-hydroxy-3-(meth)acryloxy propyl sulfonic acid];

5. Sulfonic acid salt group-containing monomers: alkali metal salts, ammonium salts, amine salts of sulfonic acid group containing monomers as mentioned above;

6. Hydroxyl group-containing monomers: monoethylenically unsaturated alcohols [such as (meth)allyl alcohol], monoethylenically unsaturated ethers or esters of polyols (alkylene glycols, glycerol, polyoxyalkylene polyols), such as hydroxethyl(meth)acrylate, hydroxypropyl(meth)acrylate, triethylene glycol(meth)acrylate, poly(oxyethylene oxypropylene)glycol mono(meth)allyl ether (in which hydroxyl groups may be etherified or esterified);

7. Amide group-containing monomers: vinylformamide, (meth)acrylamide, N-alkyl(meth)acrylamides (such as N-methylacrylamide, N-hexylacrylamide), N,N-dialkyl(meth)acryl amides (such as N,N-dimethylacrylamide, N,N-di-n-propylacrylamide), N-hydroxyalkyl(meth)acrylamides [such as N-methylol(meth)acrylamide, N-hydroxyethyl(meth)acrylamidel, N,N-dihydroxyalkyl(meth)acrylamides [such as N,N-dihydroxyethyl(meth)acrylamidel, vinyl lactams (such as N-vinylpyrrolidone);

8. Amino group-containing monomers: amino group-containing esters (e.g., dialkylaminoalkyl esters, dihydroxyalkylaminoalkyl esters, morpholinoalkyl esters, etc.) of monoethylenically unsaturated mono-or di-carboxylic acid [such as dimethlaminoethyl(meth)acrylate, diethylaminoethyl(meth)acrylate, morpholinoethyl(meth)acrylate, dimethyl aminoethyl fumarate, heterocyclic vinyl compounds such as vinyl pyridines (e.g., 2-vinyl pyridine, 4-vinyl pyridine, N-vinyl pyridine), N-vinyl imidazole;

9. Quaternary ammonium salt group-containing monomers: N,N,N-trialkyl-N-(meth)acryloyloxyalkylammonium salts [such as N,N,N-trimethyl-N-(meth)acryloyloxyethylammonium chloride, N,N,N-triethyl-N-(meth)acryloyloxyethylammonium chloride, 2-hydroxy-3-(meth)-acryloyloxypropyl trimethyl ammonium chloride]; and

10. Ether-group containing monomers: methoxy polyethylene glycol (meth)acrylate; polyethylene glycol dimethacylate.

Desirable superabsorbent-forming monomers suitable for the process of the invention include without limitation aliphatic unsaturated monocarboxylic acids or salts thereof; specifically unsaturated monocarboxylic acids or salts thereof such as acrylic acid or salts thereof, methacrylic acid or salts thereof, or unsaturated dicarboxylic acids or salts thereof such as maleic acid or salts thereof, itaconic acid or salts thereof, which may be used alone or in combination.

Among these, acrylic acid or salts thereof and methacrylic acid or salts thereof are preferred, with especially preferred being acrylic acid or salts thereof.

For example, 37.5% by weight of an 80% by weight aqueous solution of acrylic acid, to which 49.3% by weight of a 25.4% by weight aqueous solution of caustic soda may be added dropwise with the application of external cooling to neutralize to 75 mole % of the acrylic acid. Thereafter, 2.1% by weight of N,N′-methylene-bis-acrylamide may be dissolved in the resulting solution to obtain as feed monomer solution (1), an aqueous solution of a partially neutralized salt of acrylic acid, giving a monomer concentration of 42.3% by weight.

To prepare a monomer solution containing a reducing initiator (Solution A), 0.73 part by weight of L-ascorbic acid may be mixed with and dissolved in 100 parts by weight of the feed monomer solution (1). To prepare a monomer solution containing an oxidizing initiator (Solution B), 2.5 parts by weight of an aqueous solution of hydrogen peroxide having a concentration of 31% by weight may be mixed and homogenized with 100 parts by weight of the same feed monomer solution (1).

Polymerizable monomers giving a water-absorbing polymer in the present invention are preferably aliphatic unsaturated carboxylic acids or salts thereof as described above, therefore, aqueous solutions of these polymerizable monomers are preferably aqueous solutions essentially containing an aliphatic unsaturated carboxylic acid or a salt thereof. As used herein, the expression “essentially containing an aliphatic unsaturated carboxylic acid or a salt thereof” means that the aliphatic unsaturated carboxylic acid or a salt thereof is contained at 50 mol % or more, preferably 80 mol % or more on the basis of the total amount of the polymerizable monomer.

Suitable salts of aliphatic unsaturated carboxylic acids normally include water-soluble salts such as alkali metal salts, alkali earth metal salts, ammonium salts or the like. The neutrality is appropriately selected depending on the purpose, but 20-90 mol % of carboxyl group is preferably neutralized with an alkali metal salt or an ammonium salt in the case of acrylic acid. If the partial neutrality of an acrylic monomer is less than 20 mol %, the resulting water-absorbing polymer tends to have low water-absorbing capacity.

Acrylic monomers can be neutralized with alkali metal hydroxides or bicarbonates or ammonium hydroxide or the like, preferably alkali metal hydroxides such as sodium hydroxide and potassium hydroxide.

Superabsorbent-forming monomers may also include comonomers which are polymerizable along with any of the monomers listed above. The comonomers may form part of the same superabsorbent polymer precursor composition as the primary monomer, or may be part of a different superabsorbent polymer precursor composition, and may be added to the fibrous mixture using the same or different streams. While it may be desirable in some instances to add comonomers in different superabsorbent polymer precursor compositions, they may be added in the same precursor composition as the primary monomer if the primary monomer and comonomer will not spontaneously react with each other. Where the primary monomer is an aliphatic unsaturated carboxylic acid, suitable comonomers include without limitation secondary monomers such as (meth)acrylamide, (poly)ethylene glycol(meth)acrylate, 2-hydroxyethyl(meth)acrylate or even slightly water-soluble monomers including acrylate capped urethanes, acrylic alkyl esters such as methyl acrylate or ethyl acrylate may also be copolymerized in an amount within a range that does not affect performance of the resulting water-absorbing polymers in the present invention. As used herein, the term “(meth)acryl” means both “acryl” and “methacryl.”

Aliphatic unsaturated carboxylic acids or salts thereof, especially acrylic acid or salts thereof sometimes form a self-crosslinked polymer by themselves, but may be positively induced to form a crosslinked structure using a crosslinker. The use of a crosslinker normally improves water-absorbing performance of the resulting water-absorbing polymer. Preferably, suitable crosslinkers include divinyl compounds copolymerizable with said polymerizable monomers such as N,N′-methylenebis(meth)acrylamide, (poly)ethylene glycol di(meth)acrylate and water-soluble compounds having two or more functional groups capable of reacting with a carboxylic acid including polyglycidyl ethers such as ethylene glycol diglycidyl ether, polyethylene glycol diglycidyl ether. Among them, N,N′-methylenebis(meth)acrylamide is especially preferred. Crosslinkers are used in an amount of 0.001-1% by weight, preferably 0.01-0.5% by weight on the basis of the amount of the monomer, and may be added in the same superabsorbent polymer precursor composition as the monomer, or as part of a different precursor composition.

One or more polymerization initiators may be added in a different superabsorbent polymer precursor composition than the monomer(s). The polymerization initiator may be added as part of the same precursor composition as the monomer if the initiator is a single component of a redox pair. Alternatively, the polymerization initiators may be added as part of a different precursor composition as the monomer due to the fact that the polymerization initiators may act quickly to polymerize the monomer units once contact is made. When the monomer and polymerization initiator make initial contact in the ISPS reactor, the polymerization reaction is initiated, and occurs entirely within the ISPS reactor.

Polymerization initiators suitable for the present invention include without limitation somewhat water-soluble redox systems combining an oxidizing radical generator and a reducing agent. Such oxidizing agents include hydrogen peroxide, potassium bromate, N-bromosuccinimide, persulfates such as ammonium persulfate, sodium persulfate, or potassium persulfate, peroxides including hydroperoxides such as 1-butyl hydroperoxide or cumene hydroperoxide, secondary cerium salts, permanganates, chlorites, hypochlorites, etc., among which hydrogen peroxide is especially preferred. These oxidizing agents may be used in an amount of 0.001-10% by weight, desirably 0.01-2% by weight on the basis of polymerizable monomers.

Reducing agents are also used with the redox system, and may be added as part of the polymerization initiator. Suitable reducing agents are capable of forming a redox system with said oxidizing agents, specifically sulfites such as sodium sulfite or sodium hydrogensulfite, sodium thiosulfate, cobalt acetate, copper sulfate, ferrous sulfate, ferrous ammonium sulfate, sodium metabisulfite, tertiary amines or diamines, L-ascorbic acid or L-ascorbic acid alkali metal salts, etc. Among others, L-ascorbic acid or L-ascorbic acid alkali metal salts are especially preferred. These reducing agents are used in an amount of 0.001-10% by weight, preferably 0.01-2% by weight on the basis of polymerizable monomers. Desirably, the precursor composition containing the oxidizing radical generator is added using a different addition stream than is used for the reducing agents.

Other suitable polymerization initiators include those induced by radiation. For example, an ultraviolet initiator may be included in the superabsorbent polymer precursor composition, and may be activated when exposed to ultraviolet light. Similarly, electron-beam radiation may also be used to induce polymeriziation in the method of the invention. Any suitable radiation-induced initiation may be used in the method of the invention.

Process conditions, feed rates, and the like should be tailored to produce the desired composition for the superabsorbent-fiber composite.

Where a redox system of polymerization initiator(s) as described above is employed, the chemical reaction proceeds spontaneously. Otherwise, depending on the mechanism of chemical reaction employed, it may be necessary to raise the temperature within the ISPS reactor, irradiate it, or employ some other treatment in order to facilitate and optimize the chemical reaction.

In one embodiment of the invention, a first superabsorbent polymer precursor composition may contain all of the essential polymerization ingredients except for one initiator, which can be either an oxidizing agent or a reducing agent. The second superabsorbent polymer precursor composition may contain only that one initiator. When the first and second superabsorbent polymer precursor compositions come in contact with each other in the ISPS reactor, the chemical reaction proceeds spontaneously to form superabsorbent polymer.

In one embodiment of the invention, first and second superabsorbent polymer precursor compositions are combined in the ISPS reactor, and are chemically reacted to form a superabsorbent polymer. Then, to further advance and complete the chemical reaction, a third superabsorbent polymer precursor composition (for instance, one containing a second polymerization initiator or a second quantity of an original polymerization initiator) is added to the ISPS reactor.

Examples of superabsorbent polymers which may be formed in situ include without limitation the alkali metal and ammonium salts of poly(acrylic acid) and poly(methacrylic acid), poly(acrylamides), poly(vinyl ethers), maleic anhydride copolymers with vinyl ethers and alpha-olefins, poly(vinyl pyrrolidone), poly(vinylmorpholinone), poly(vinyl alcohol), and mixtures and copolymers thereof. Further superabsorbent materials (some of which may be formed before addition to the ISPS reactor) include natural and modified natural polymers, such as hydrolyzed acrylonitrile-grafted starch, acrylic acid grafted starch, methyl cellulose, chitosan, carboxymethyl cellulose, hydroxypropyl cellulose, and the natural gums, such as alginates, xanthan gum, locust bean gum and the like. Mixtures of natural and wholly or partially synthetic superabsorbent polymers can also be useful in the present invention. Other suitable absorbent gelling materials are disclosed by Assarsson et al. in U.S. Pat. No. 3,901,236 issued Aug. 26, 1975. Known processes for preparing synthetic absorbent gelling polymers are disclosed in U.S. Pat. No. 4,076,663 issued Feb. 28, 1978 to Masuda et al. and U.S. Pat. No. 4,286,082 issued Aug. 25, 1981 to Tsubakimoto et al.

Various types of individualized fibers can be used to form the ISPS-fiber material. These fibers may include natural or synthetic fibers, such as cellulose fibers, micro-fibrillated cellulose, cotton, wood pulp fibers, wood pulp fluff, curled pulp fibers, microcrystalline cellulose, bicomponent fibers, elastomeric fibers, and the like, or combinations of any of these. Other hydrophilic fibers may also be employed, as well as absorbent staple fibers.

When thermoplastic fibers are employed, they may include meltblown fibers. The meltblown fibers may be formed from thermoplastic polymers including, without limitation, polyolefins, polyamides, polyester, polyurethane, polyvinyl alcohol, polycaprolactone, styrene butadiene block copolymers or the like. Suitable polyolefins include without limitation polyethylene, polypropylene, polybutylene, copolymers of ethylene with other alpha-olefins, copolymers of propylene with other alpha-olefins, copolymers of butylene with other alpha-olefins, and combinations thereof.

When thermoplastic polymers are employed, they may include spunbond fibers formed from any of the thermoplastic polymers listed above as being useful for meltblown fibers.

When thermoplastic staple fibers are employed they also may include fibers formed from any of the thermoplastic polymers listed above as being useful for meltblown fibers.

In one embodiment, one or more functional additives can be added to the individualized fibers prior to, during, or after adding the fibers to the ISPS reactor in order to produce multifunctional superabsorbent-fiber composites. Suitable additives may include odor-controlling agents, foaming agents, perfumes, medicinal agents, pH-controlling agents, anionic inorganic salts or anionic polymers to entrap cationic components in the fluid, or combinations of any of these additives.

In another embodiment, two or more different types of fibers are included in the ISPS-fiber material. Alternatively, a second and/or third or more fiber type can be introduced into the ISPS-fiber material in the metering-forming system. One particularly attractive fiber type to introduce at this point is elastomeric fibers, particularly melt-processed (e.g. meltblown) elastomeric fibers. This structure provides an elastomeric absorbent with enhanced superabsorbent shakeout resistance. In one particular embodiment, a superabsorbent-fiber composite including elastomeric fibers may be stretched by a stretching elongating force by at least about 25% of a relaxed length of the composite, and can recover at least about 40% of its elongation upon release of the stretching elongating force.

The resulting superabsorbent-fiber composite includes a plurality of fibers having superabsorbent particles formed in situ. The average dry particle diameter may range from about 10-1000 microns, desirably about 20-500 microns. A primary advantage of the superabsorbent-fiber composites of the invention is that the superabsorbent particles are fairly evenly distributed and they combine with or hold to the fibers, so that the distance between the superabsorbent particles is maintained. The ISPS particles are combined with fibers tenaciously so that the ISPS particles are not easily separated from the attached fibers by vigorous agitation or vibration either in the dry state or even in the wet state. This is one of the distinct advantages of the ISPS-fiber material over a conventional superabsorbent-pulp fluff mixture since in the latter superabsorbent particles are relatively easily detached from the pulp fluff causing superabsorbent particle migration and gel-on-skin.

In yet another embodiment, the superabsorbent-particulate material formed by flash-drying polymerized superabsorbent-particulate material in the absence of fibers can be transformed into a superabsorbent-fiber material by adding fibers to the superabsorbent-particulate material subsequent to the flash-drying step.

The ISPS-fiber materials and composites of the invention are useful in a wide variety of absorbent articles, particularly as absorbent core material in personal care absorbent articles, medical absorbent articles, and tissue and wiping absorbent articles. Personal care absorbent articles include diapers, training pants, swim wear, absorbent underpants, baby wipes, adult incontinence products, feminine hygiene products and the like. Medical absorbent articles include medical absorbent garments, drapes, gowns, bandages, wound dressings, underpads, wipes, and the like. Tissue and wiping absorbent articles include facial tissue, paper towels such as kitchen towels, away-from-home towels, wet-wipes, and the like.

While the embodiments of the invention disclosed herein are presently preferred, various modifications and improvements can be made without departing from the spirit and scope of the invention. The scope of the invention is indicated by the appended claims, and all changes that fall within the meaning and range of equivalents are intended to be embraced therein.

What is claimed is:

1. A method of making an absorbent material, comprising the steps of:
providing a superabsorbent polymer precursor composition containing an initiator;
initiating polymerization of the superabsorbent polymer precursor composition;
polymerizing the superabsorbent polymer precursor composition to form a superabsorbent-particulate material; and
flash-drying the polymerized superabsorbent-particulate material at a temperature greater than about 150 degrees Celsius.

2. The method of claim 1, further comprising the step of adding at least one functional additive, selected from the group consisting of an odor-controlling agent, a foaming agent, a perfume, a medicinal agent, a pH-controlling agent, an anionic inorganic salt, and an anionic polymer, to the polymerized superabsorbent-particulate material.

3. The method of claim 1, wherein the initiation step is carried out using radiation-induced initiation.

4. The method of claim 1, wherein the initiator comprises one of a reducing initiator and an oxidizing initiator, and the initiation step is carried out by combining the superabsorbent polymer precursor composition containing the initiator with at least one of an oxidizing initiator and a reducing initiator.

5. The method of claim 1, further comprising the step of adding individualized fibers to the dried polymerized superabsorbent-particulate material.

6. The method of claim 1, comprising flash-drying the polymerized superabsorbent-particulate material at a temperature greater than about 300 degrees Celsius.

7. The method of claim 1, comprising flash-drying the polymerized superabsorbent-particulate material for less than about 30 seconds.

8. The method of claim 1, comprising flash-drying the polymerized superabsorbent-particulate material for less than about 20 seconds.

9. The method of claim 1, comprising flash-drying the polymerized superabsorbent-particulate material for between about 0.1 seconds to about 10 seconds.

10. The method of claim 1, further comprising the step of adding the polymerized superabsorbent-particulate material to a substrate to form a superabsorbent composite structure.

11. A method of making a superabsorbent-fiber material, comprising the steps of:
providing a superabsorbent polymer precursor composition containing an initiator;
initiating polymerization of the superabsorbent polymer precursor composition;
adding a plurality of individualized fibers to the superabsorbent polymer precursor composition to form an in-situ polymerized superabsorbent-fiber material; and
flash-drying the in-situ polymerized superabsorbent-fiber material at a temperature greater than about 150 degrees Celsius.

12. The method of claim 11, wherein the initiation step is carried out using radiation-induced initiation.

13. The method of claim 11, wherein the initiator comprises one of a reducing initiator and an oxidizing initiator, and the initiation step is carried out by combining the superabsorbent polymer precursor composition containing the initiator with at least one of an oxidizing initiator and a reducing initiator.

14. The method of claim 11, wherein the plurality of individualized fibers comprises at least one of the group consisting of cellulose fibers, micro-fibrillated cellulose, cotton, wood pulp fibers, wood pulp fluff, curled pulp fibers, microcrystalline cellulose, synthetic fibers, bicomponent fibers, elastomeric fibers, meltblown fibers, spunbond fibers, staple fibers, and combinations thereof.

15. The method of claim 11, wherein a ratio of a feed rate of the superabsorbent polymer precursor composition to a feed rate of the plurality of individualized fibers into a reactor in which the plurality of individualized fibers are added to the superabsorbent polymer precursor composition is between about 5:95 and about 95:5.

16. The method of claim 11, further comprising the step of adding at least one functional additive, selected from the group consisting of an odor-controlling agent, a foaming agent, a perfume, a medicinal agent, a pH-controlling agent, an anionic inorganic salt, and an anionic polymer, to the plurality of individualized fibers.

17. The method of claim 11, comprising flash-drying the in-situ polymerized superabsorbent-fiber material at a temperature greater than about 300 degrees Celsius.

18. The method of claim 11, comprising flash-drying the in-situ polymerized superabsorbent-fiber material for less than about 30 seconds.

19. The method of claim 11, comprising flash-drying the in-situ polymerized superabsorbent-fiber material for less than about 20 seconds.

20. The method of claim 11, comprising flash-drying the in-situ polymerized superabsorbent-fiber material for between about 0.1 seconds to about 10 seconds.

21. The method of claim 11, further comprising the step of forming continuous sheets of a superabsorbent-fiber composite from the dried in-situ polymerized superabsorbent-fiber material.

22. The method of claim 21, further comprising the step of thinning the superabsorbent-fiber composite.

23. The method of claim 21, further comprising the step of defestooning or unwinding the continuous sheets of the superabsorbent-fiber composite and converting the superabsorbent-fiber composite into absorbent articles.

24. The method of claim 11, further comprising the step of depositing the in-situ polymerized superabsorbent-fiber material onto a substrate to form an in-situ polymerized superabsorbent-fiber laminated composite structure.

25. An absorbent article comprising the superabsorbent-fiber material made according to the method of claim 11.

26. A method of making a superabsorbent-fiber composite, comprising the steps of:
providing a superabsorbent polymer precursor composition containing an initiator;
initiating polymerization of the superabsorbent polymer precursor composition;
adding a plurality of individualized fibers to the superabsorbent polymer precursor composition to form an in-situ polymerized superabsorbent-fiber material;
flash-drying the in-situ polymerized superabsorbent-fiber material at a temperature greater than about 150 degrees Celsius;
metering the dried in-situ polymerized superabsorbent-fiber material; and
forming the superabsorbent-fiber composite from the dried in-situ polymerized superabsorbent-fiber material.

27. The method of claim 26, wherein the initiation step is carried out using radiation-induced initiation.

28. The method of claim 26, wherein the initiator comprises one of a reducing initiator and an oxidizing initiator, and the initiation step is carried out by combining the superabsorbent polymer precursor composition containing the initiator with at least one of an oxidizing initiator and a reducing initiator.

29. The method of claim 26, wherein the plurality of individualized fibers comprises at least one of the group consisting of cellulose fibers, micro-fibrillated cellulose, cotton, wood pulp fibers, wood pulp fluff, curled pulp fibers, microcrystalline cellulose, synthetic fibers, bicomponent fibers, elastomeric fibers, meltblown fibers, spunbond fibers, staple fibers, and combinations thereof.

30. The method of claim 26, further comprising the step of adding at least one functional additive, selected from the group consisting of an odor-controlling agent, a foaming agent, a perfume, a medicinal agent, a pH-controlling agent, an anionic inorganic salt, and an anionic polymer, to the plurality of individualized fibers.

31. The method of claim 26, wherein the in-situ polymerized superabsorbent-fiber material comprises in-situ polymerized superabsorbent particles and the plurality of individualized fibers in a ratio between about 5:95 and about 95:5.

32. The method of claim 26, further comprising the step of adding additional individualized fibers to the dried in-situ polymerized superabsorbent-fiber material while forming the superabsorbent-fiber composite.

33. The method of claim 32, wherein the additional individual fibers comprise elastomeric fibers.

34. An absorbent article comprising the superabsorbent-fiber composite made according to the method of claim 33, wherein the superabsorbent-fiber composite can be stretched by a stretching elongating force by at least about 25% of a relaxed length, and can recover at least about 40% of its elongation upon release of the stretching elongating force.

35. A method of making a superabsorbent-fiber material, comprising the steps of:
providing a superabsorbent polymer precursor composition containing an initiator;
initiating polymerization of the superabsorbent polymer precursor composition;
adding a plurality of individualized fibers to the superabsorbent polymer precursor composition to form an in-situ polymerized superabsorbent-fiber material;
flash-drying the in-situ polymerized superabsorbent-fiber material at a temperature greater than about 150 degrees Celsius; and
forming bales of the superabsorbent-fiber material from the dried in-situ polymerized superabsorbent-fiber material.

36. The method of claim 35, wherein the initiation step is carried out using radiation-induced initiation.

37. The method of claim 35, wherein the initiator comprises one of a reducing initiator and an oxidizing initiator, and the initiation step is carried out by combining the superabsorbent polymer precursor composition containing the initiator with at least one of an oxidizing initiator and a reducing initiator.

38. The method of claim 35, wherein the plurality of individualized fibers comprises at least one of the group consisting of cellulose fibers, micro-fibrillated cellulose, cotton, wood pulp fibers, wood pulp fluff, curled pulp fibers, microcrystalline cellulose, synthetic fibers, bicomponent fibers, elastomeric fibers, meltblown fibers, spunbond fibers, staple fibers, and combinations thereof.

39. The method of claim 35, wherein the plurality of individualized fibers comprises at least two different types of fibers.

40. The method of claim 35, further comprising the step of adding at least one functional additive, selected from the group consisting of an odor-controlling agent, a foaming agent, a perfume, a medicinal agent, a pH-controlling agent, an anionic inorganic salt, and an anionic polymer, to the plurality of individualized fibers.

41. The method of claim 35, wherein the in-situ polymerized superabsorbent-fiber material comprises in-situ polymerized superabsorbent particles and the plurality of individualized fibers in a ratio between about 5:95 and about 95:5.

42. The method of claim 35, further comprising the step of opening and metering the baled superabsorbent-fiber material.

43. The method of claim 42, further comprising the step of forming the superabsorbent-fiber material into a shaped absorbent article.
